(19) United States
(12) Patent Application Publication
(10) Pub. No.: US 2026/0013485 A1
(43) Pub. Date: Jan. 15, 2026

(54) Box Nesting Marine Trap

(71) Applicant: Dean Ray Schreiber, JR., Roy, WA (US)

(72) Inventor: Dean Ray Schreiber, JR., Roy, WA (US)

(21) Appl. No.: 19/220,110

(22) Filed: May 28, 2025

Related U.S. Application Data
(60) Provisional application No. 63/652,643, filed on May 28, 2024.

(51) Int. Cl. A01K 69/08

(52) U.S. Cl. CPC A01K 69/08

(57) ABSTRACT

A marine trap for catching crab, shrimp, crawfish, lobster, and other forms of marine life. The trap is a trapezoidal prism design. This concaved design permits nesting for increased volume in the same area for both in storage and on a boat deck. The right corner shape conserves space by eliminating wasted deck space caused by round marine traps.

### REFERENCE TO RELATED APPLICATIONS

This application claims the benefit of U.S. Provisional Patent Application No. 63/652,643, filed on May 28, 2024.

### FIELD OF THE INVENTION

Related to crab, shrimp, crawfish, lobster, and other marine life traps.

### BACKGROUND OF THE INVENTION

Marine traps are used to fish for various marine life. Most commercially available traps/pots are round or square in shape. Most are rigid and fixed. They occupy more space than necessary. Some variations of round and collapsible traps exist on the market. The traps are limited to certain marine life and do not address availability well in the Pacific Northwest.

### SUMMARY OF THE INVENTION

By creating a marine trap that is a trapezoidal prism, space can be maximized. The shape allows for more usable space on a boat and during storage. Nesting allows for more traps to occupy the same space where far fewer would normally occupy. The detailed description will provide further details.

### BRIEF DESCRIPTION OF DRAWINGS

The following detailed description section will refer to drawings that have numbers present for more detailed description.

### DETAILED DESCRIPTION OF THE INVENTION

The detailed description will depict a crab pot; however, the details should not be solely limited to just crab. This trap may be used for other marine life with minor modifications. These modifications can be to the door size or using a tunnel or ramp in place of doors. The escapement method may also be altered depending on the marine life to be targeted. The trap may also take on a rectangular shape instead of a square shape.

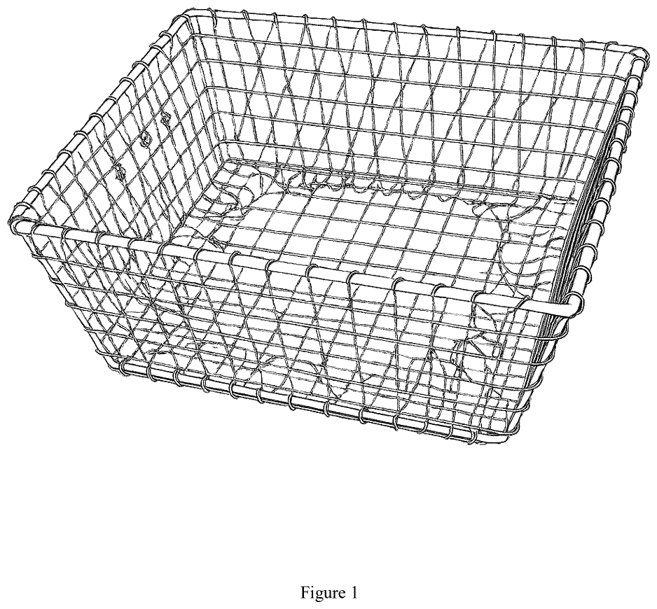

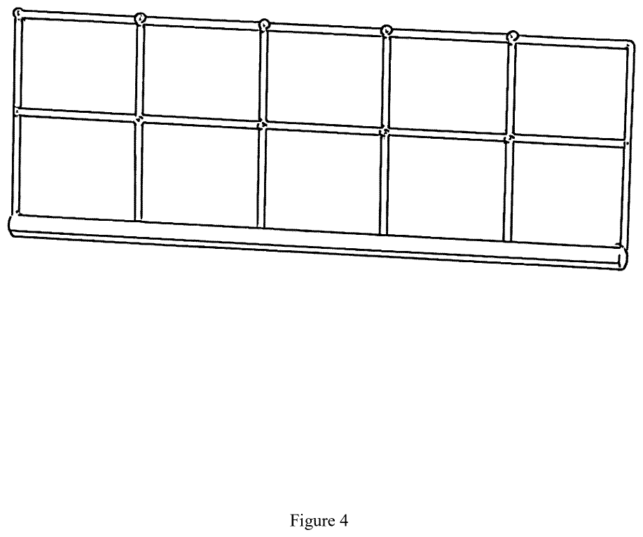

FIG. 1—The trap is a trapezoidal prism shape and shows how the net falls into the trap to allow nesting. The sides are also concaved, which helps direct marine life towards the doors seen in FIG. 4.

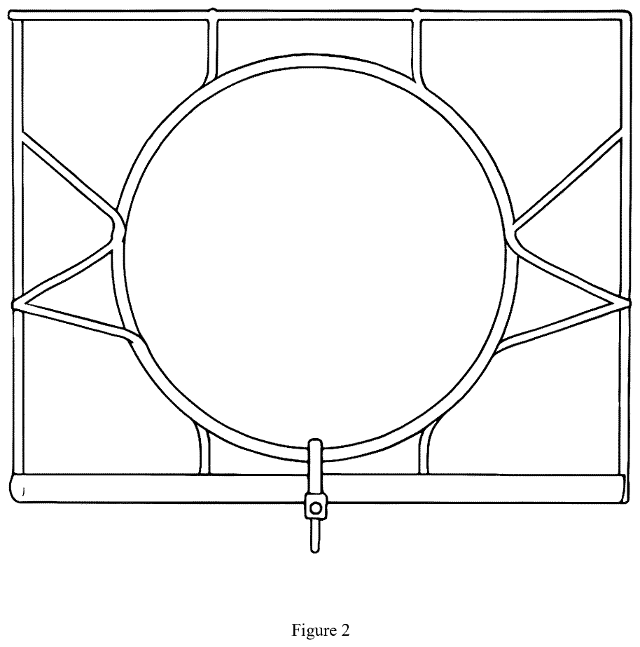

FIG. 2—Escapement method. The trap has a rot cord tying a 4.25-inch escapement ring as required by Washington State. After an extended time, the rot cord will break and allow marine life to escape more freely. The ring has wrap that will not rot. This allows retention of the ring to not pollute the waterways.

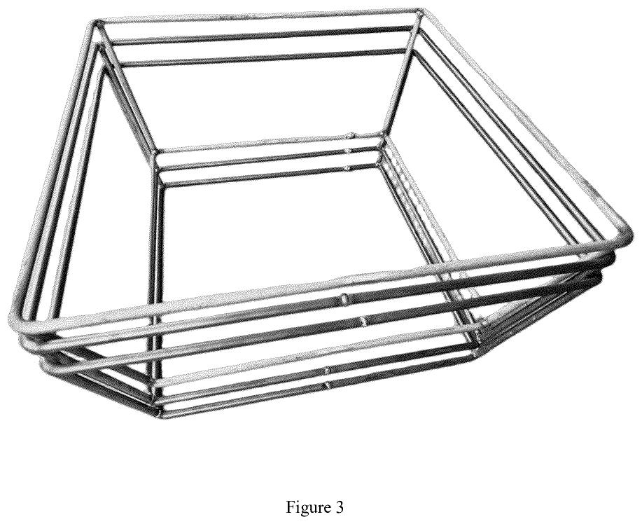

FIG. 3—Shows the frames of the traps and displays the nesting feature. The concaved design allows them to nest into each other conserving and maximizing space. Buoys and rope may also be stored between the pots, conserving even greater space. When looking from overhead, the right-angle design does not leave any gaps with unused space between stacks, allowing for more in less area.

FIG. 4—Shows a marine door that is weighted. This weighted door helps fight currents letting the doors stay closed to retain marine life. This door could be placed anywhere along the sides of the trap, depending upon the marine life targeted and may be substituted for a ramp or tunnel. In this instance, there are doors located at the bottom of all four sides of the traps to target Dungeness crab.

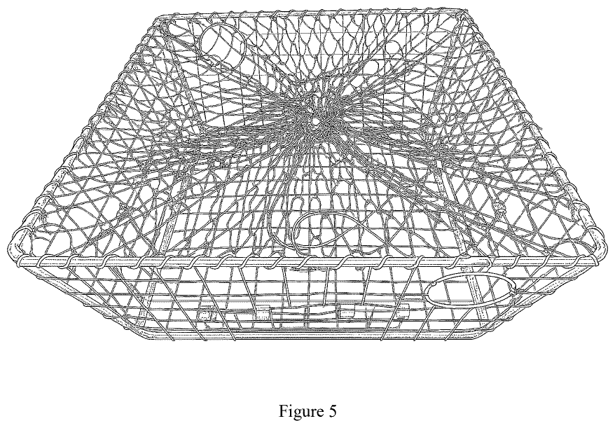

FIG. 5—Displays the drawstring pulled with the net taunt for the trap to be ready to deploy.

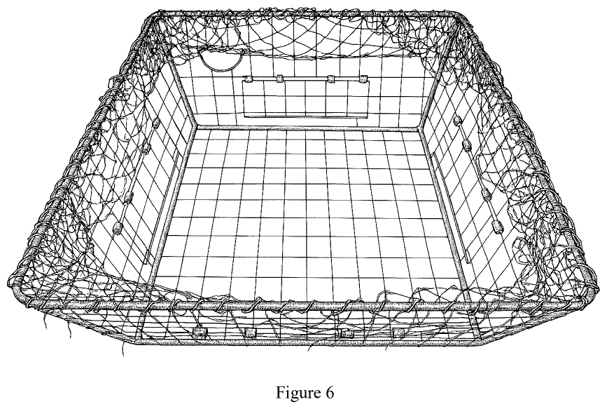

FIG. 6—Shows the net being rolled to the outside of the trap to allow complete access for marine life removal.

1. A marine trap that is a Trapezoidal prism to allow nesting as shown in FIG. 3.

2. A marine trap that is nestable with right corners top and bottom as shown in FIGS. 1,5,6.

3. A marine trap with a retainable escapement system as shown in FIG. 2.

4. A marine trap that is a trapezoidal prism with the large side being closeable to retain marine life as shown in FIGS. 1,5.

5. A marine trap with a weighted door to prevent opening in currents as shown in FIG. 5.
